(19) United States
(12) Patent Application Publication
(10) Pub. No.: US 2003/0037255 A1
(43) Pub. Date: Feb. 20, 2003

(54) Measuring equipment and method of preparing measurement data

(75) Inventors: Yasuhiro Yoshino, Tokyo (JP); Tsuyoshi Tsuchiya, Tokyo (JP); Hiroyuki Katamata, Tokyo (JP); Tatsuya Fukuhara, Tokyo (JP)

Correspondence Address: ARMSTRONG,WESTERMAN & HATTORI, LLP, 1725 K STREET, NW., SUITE 1000, WASHINGTON, DC, 20006, US

(73) Assignee: Yokogawa Electric Corporation, Musashino-shi (JP)

(21) Appl. No.: 10/166,382

(22) Filed: Jun. 11, 2002

(30) Foreign Application Priority Data
Aug. 15, 2001 (JP) 2001-246370
Sep. 20, 2001 (JP) 2001-286781
Mar. 5, 2002 (JP) 2002-059161

(51) Int. Cl. H04L 9/00

(52) U.S. Cl. 713/200

(57) ABSTRACT

The present invention is characterized by the following. Data for administrating equipment and measurement results are prepared prior to measurement of the prescribed input signal, measurement files consisting of measurement results are prepared and recorded on a storage medium during measurement, and a digital signature is affixed to these files after measurement. These characteristics enable the data to be handled as official data enabling restriction of access to the equipment and measurement data, operation logs and records of measurement conditions, and writing of signatures.

### BACKGROUND OF THE INVENTION

1. Field of the Invention

The present invention relates to the measuring equipment in which a prescribed input signal is converted to electronic data, digitized (hereafter simply called ‘digitized’ including conversion and digitization) and then recorded on a storage medium and a method of preparing measurement data, and in particular, relates to improvement of reliability of recorded data.

2. Description of the Prior Art

Reliability is essential for measurement results obtained with measuring instruments for monitoring pharmaceutical manufacturing processes subject to inspections by official bodies. Specific examples of requirements for such reliability and passing inspections include restricting access to measurement results, operation logs and records of measurement conditions, writing signatures on data attestations, etc. required by the U.S. Food and Drug Administration in audits to pharmaceuticals manufacturers. These are called audit trails.

However, conventional storage equipment for recording digitized measurement data on a storage medium, which is the recent most common handling form, cannot record the above requirements for the measurement data being recorded.

For this reason, in the above example, the above conventional storage equipment is not sufficient for audit trails required in audits to pharmaceuticals manufacturers by the U.S. Food and Drug Administration. Specifically in writing the signature of a user who has attested measurement data, if the data are electronic, the present method is for the user to sign the printed electronic data using a personal computer or the like, or to adopt the user signature affixed to a sheet of chart on which the data are recorded using a chart recorder as measurement results.

These will be detailed taking a conventional system as an example.

FIG. 1 is a drawing showing an example of configuration for the conventional measuring equipment in which prescribed input signals are digitized and recorded on a storage medium as measurement data.

In FIG. 1, an input signal such as voltage is converted into electronic data with measurement circuit 10 and the data measured in a preset period from memory start to memory stop are stored in internal memory 3 via control means 21. The measurement data stored in the internal memory are recorded on storage medium 4 in the form of files at memory stop.

In the past, the information recorded in storage medium 4 included only the measurement data, the information for indicating the measurement data in waveforms, information for alarms and messages generated during measurement, and information on the user who started and stopped memory.

In this case, there is a problem that files recorded on storage medium 4 cannot meet the requirements of the above-described pharmaceutical industries or the like, such as restrictions on access to the data, operation logs and records of measurement conditions, and writing of signatures, and thus cannot be used as official data.

### SUMMARY OF THE INVENTION

The present invention is intended to overcome the above-described problem. The objective of the present invention is to devise the measuring equipment, that can handle restrictions on access to the equipment and digitized data, operation logs and records of setup information, and writing of signatures, such data of which can be handled as official data, and to provide a method of preparing such measurement data.

### BRIEF DESCRIPTION OF DRAWINGS

FIG. 1 is a drawing showing an example of a configuration of conventional measuring equipment.

FIG. 2 is a drawing of the entire configuration for embodiment 1 of the present invention.

FIG. 3 is a drawing of a configuration showing the details of the control part in embodiment 1 of the present invention.

FIG. 4 is a flowchart showing an example of the procedure for preparing measurement data.

FIG. 5 shows an example of administrator registration screen based on the administrator registration means.

FIG. 6 shows an example of log-in screen based on the administrator attestation means.

FIG. 7 shows an example of the user registration screen based on the user registration means.

FIG. 8 shows an example of the sign-in screen based on the sign-in part.

FIG. 9 is a drawing of a configuration showing embodiment 2 of the present invention.

FIG. 10 is a flowchart showing an example of the procedure for sign-in using other equipment.

FIG. 11 is a conceptual configuration drawing showing embodiment 3 of the present invention.

FIG. 12 shows a drawing showing an example of key arrangement for remote control 2.

FIG. 13 shows an example of the remote control ID setup screen.

FIG. 14 shows an example of the system information screen.

FIG. 15 is a block diagram showing a practical example of a recorder based on the present invention.

FIG. 16 shows a flowchart showing an example of the procedure for sign-in using other equipment in the present invention.

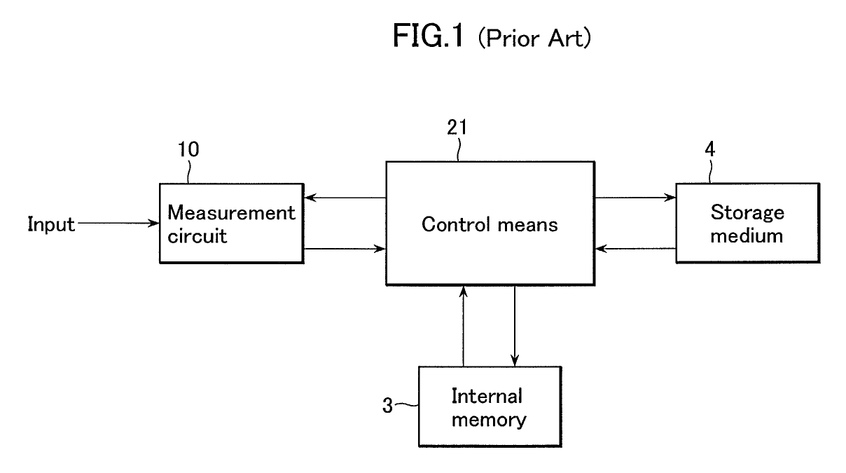

### DESCRIPTION OF THE PREFERRED EMBODIMENTS

The present invention will be described below in detail with reference to the drawings.

(Embodiment 1)

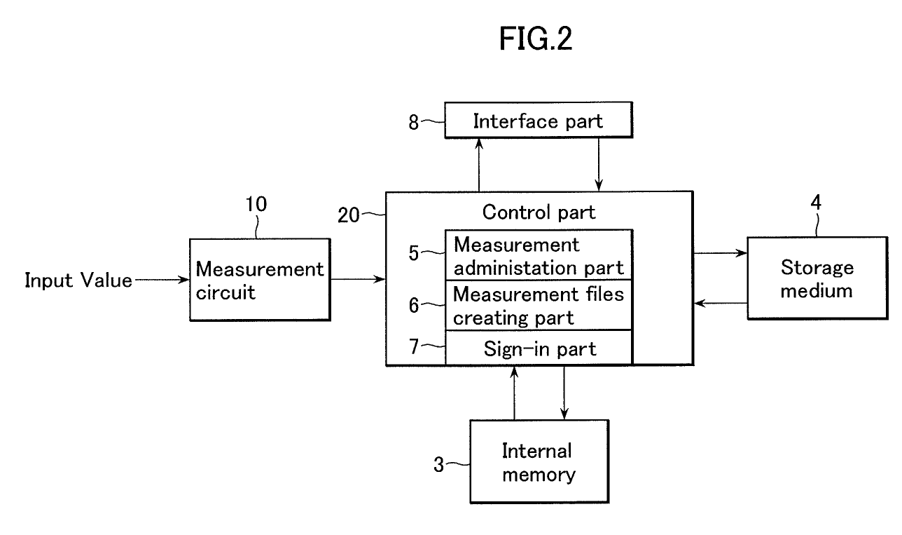

FIG. 2 is a drawing showing the entire configuration for embodiment 1 of the present invention.

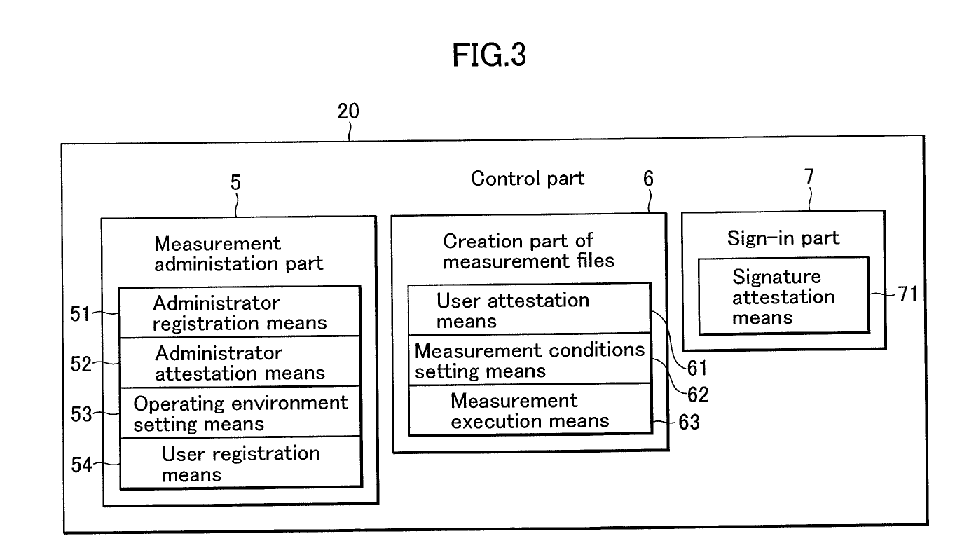

FIG. 3 is a drawing for the configuration showing the detail of control part 20 in FIG. 2. In this embodiment, measurement administration part 5, measurement files creating part 6 and sign-in part 7 are provided in control part 20.

In addition, the same sections as those in the former drawing have the same signs in FIG. 2 and FIG. 3, and thus description of those sections will be omitted.

In FIG. 3, measurement administration part 5 is a part in which administration data are prepared by the work of an administrator. Administrator registration means 51 prepares administrator data based on the administrator information such as the administrator name, user ID and password, etc. input from interface part 8 to register the administrator. Administrator attestation means 52 attests utilization of the equipment as the administrator. In details, if the administrator information input again to the equipment from interface part 8 coincides with the registered data, log-in becomes possible and utilization of the equipment is attested.

Operating environment setting means 53 sets up the date and time and system mode with operations in interface part 8 and prepares operating environment data. The contents of system mode include, for example, alarm setting for alarm generation and response thereto, memory setting such as the method of recording on a storage medium, communication setup, etc.

User registration means 54 is a means in which the user list is created based on the administrator information such as the user name, user ID and password, etc. input from interface part 8 to register them. By this means, the users who can operate the equipment are registered and the scope of operation for every user is set up. When the administrator finishes the work and terminates to use the measurement administration part, the administrator logs out from the equipment.

Measurement files creating part 6 is a part in which measurement files are prepared and recorded on storage medium 4.

User attestation means 61, when a user uses the equipment, attests the utilization of the equipment if the user information such as user name, user ID, password, etc. input from interface part 8 coincides with the user information registered by the administrator, and makes the user log-in to the equipment.

Measurement conditions setting means 62 sets up the prescribed measurement conditions such as measuring range, alarm, etc., arbitrarily sets up batch numbers for monitoring manufacturing processes using batch processing, and sets up comments or the like, by the operation in interface part 8 when measurement is done. Control part 20 stores the data for operation logs, data for measurement conditions setup, and the data for their setting logs in internal memory 3.

Measurement execution means 63 starts or stops measurement according to operations in interface part 8, and measurement data and the data for operation logs during the period from measurement start to measurement stop are stored in internal memory 3 by means of control part 20.

Finally, the measurement files creating part 6 records the data for operation logs, data for measurement conditions setup, and data for their setting logs stored in internal memory 3 by making them correspondent to measured data on storage medium 4 in the form of files.

Sign-in part 7 is a part where the digital signature is affixed to the above-described measurement files.

Signature attestation means 71 attests the user's digital signature if all the user information such as user name, user ID, and password input from interface part 8 coincides with those already registered.

In addition, an input means that adds information for signing-in with a plurality of authorities, for judging whether measurement data, the object of the signature, are valid or invalid, and/or for adding any comment to the digital signature may be provided. The user logs out from the equipment upon finishing the work and stopping the use of the equipment.

As shown by the above description, centralized administration of the equipment is made possible through registration of the administrator, setup of operating environment of the equipment by its specific administrator, registration of personnel who use the equipment, etc.

In addition, security can be ensured because access to the equipment and measurement data by unspecified persons wishing to use the equipment is rejected by the user attestation means that attests persons wishing to use the equipment and because the user who is attested with the signature attestation means affixes a digital signature.

Further, since the digital signature, equipment operation logs, measurement conditions setup data and their setup logs, etc. are recorded corresponding to the measured data, measurement data reliability can be improved.

Furthermore, a user may sign-in after once logging out from the equipment after starting measurement and again logging in to the equipment after the required data have been taken making measurement stopped. The security of the equipment under measurement can thus be ensured.

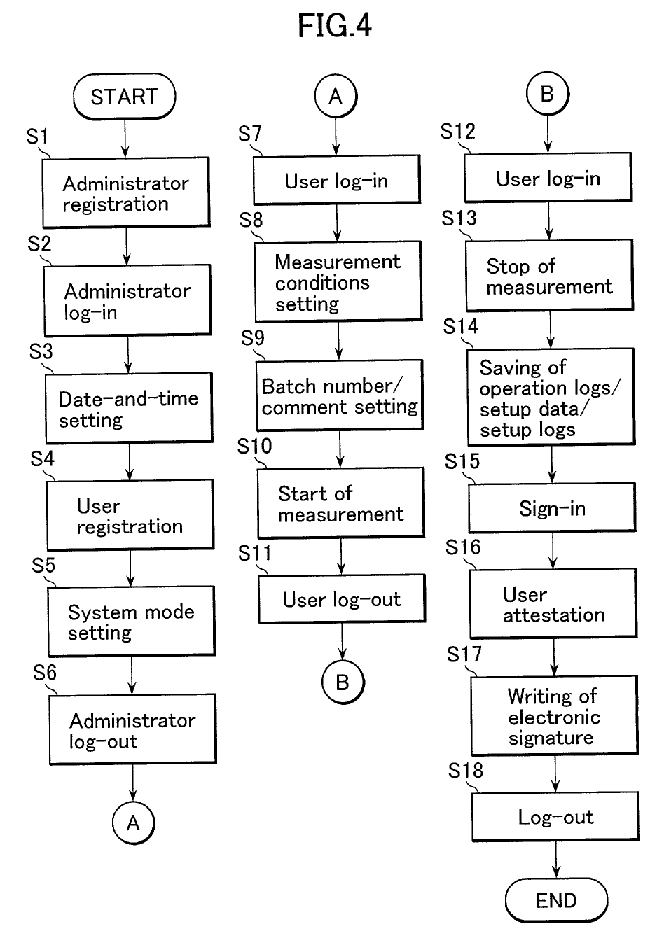

FIG. 4 is a flowchart showing an example of the procedure of preparing measurement data in the method thereof, in which measurement data are created corresponding to the prescribed setup data in the present invention. This flowchart will be interpreted according to its processing procedure.

(S1) Prepare administrator data in the equipment and register the administrator.

(S2) The administrator is attested with the above administrator data to log-in the equipment.

(S3) The administrator sets up the date-and-time to create operating environment data.

(S4) The administrator prepares a user list to register users.

(S5) The administrator sets up the system mode to prepare operating environment data.

(S6) The administrator logs out from the equipment.

(S7) A user is attested with the above-described user list to log-in to the equipment.

(S8) The user sets up measurement conditions to the equipment.

(S9) Set the batch number and comment.

(S10) The user makes the equipment start measurement.

(S11) The user logs out from the equipment.

(S12) The user logs in to the equipment.

(S13) The user makes the equipment stop measurement.

(S14) Prepare the measurement files in which operation logs, setup data and setting change logs are made to correspond to the measurement data to record them on a storage medium.

(S15) The user executes sign-in from the equipment.

(S16) Attest the user who is to execute sign-in to write the digital signature using the above user list.

(S17) Write the digital signature in the above measurement files.

(S18) The user logs out from the equipment.

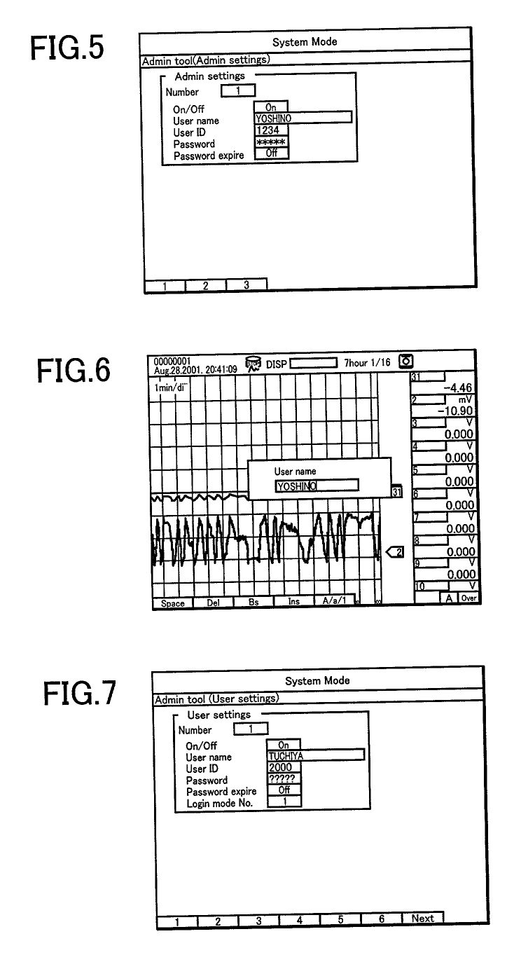

FIG. 5 shows an example of administrator registration screen based on the administrator registration means. Enter the user name, user ID and password from this screen.

FIG. 6 shows an example of log-in screen based on the administrator attestation means.

Execute log-in as the administrator who is registered on the administrator registration screen shown in FIG. 5. If the entered user name is registered, the user ID input screen (not shown) is displayed. If the entered user ID coincides with the one already registered, the password input screen (not shown) is displayed. If the entered password coincides with the one already registered, log-in is completed.

The procedure for the user log-in in the user attestation means applies correspondingly to the log-in of administrator.

FIG. 7 shows an example of user registration screen based on the user registration means.

The user who uses the equipment should be registered by entering the user name, user ID and password. In addition, the scope of operating the equipment can be set for every user (not shown).

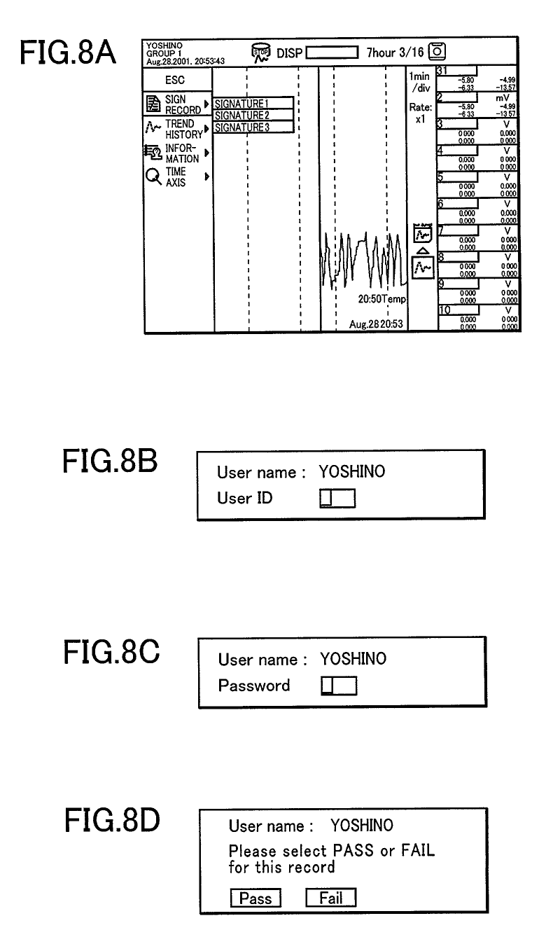

FIG. 8 shows an example of the sign-in screen based on the sign-in part.

In (a) of FIG. 8, sign-in using up to three types of authorities can be executed, one of which must be selected. The name of the person who is being log-in to the equipment is displayed as the user name. When the user ID is entered in the screen shown in (b) and the password is entered in the screen shown in (c), if the entered information coincides with the registered information, the screen shown in (d) appears and sign-in is completed after selecting whether the measurement data are valid or invalid in this screen.

In this case, the measuring equipment of the present invention may be used for recording measurement data usable for official attestation or the like, not limited in the pharmaceuticals industry but also for other industries.

As stated above, the present invention makes it possible to centrally administer the equipment by using registration of the administrator, setup of the operating environment of the equipment by its specified administrator, registration of the persons who use the equipment, etc.

In addition, security can be ensured because access to the equipment and measurement data by unspecified persons wishing to use the equipment is rejected by the user attestation means that attests persons wishing to use the equipment, and because only the user who is attested with the signature attestation means can execute the digital signature.

Further, since digital signatures can be adopted, and since the data for equipment operation logs, data for measurement conditions setup and their setup logs, etc. are recorded corresponding to the measurement data, measurement data reliability can be improved.

This makes it possible to restrict access to the equipment and measurement data, to avoid the need for printing the data as digital signatures can be executed in the equipment for digitized data, and to allow measurement data to be handled in the same way as the measurement records recorded with conventional chart recorders. Thus, the equipment is sufficient for audits by the U.S. Food and Drug Administration conducted, for example, in the pharmaceuticals industry.

(Embodiment 2)

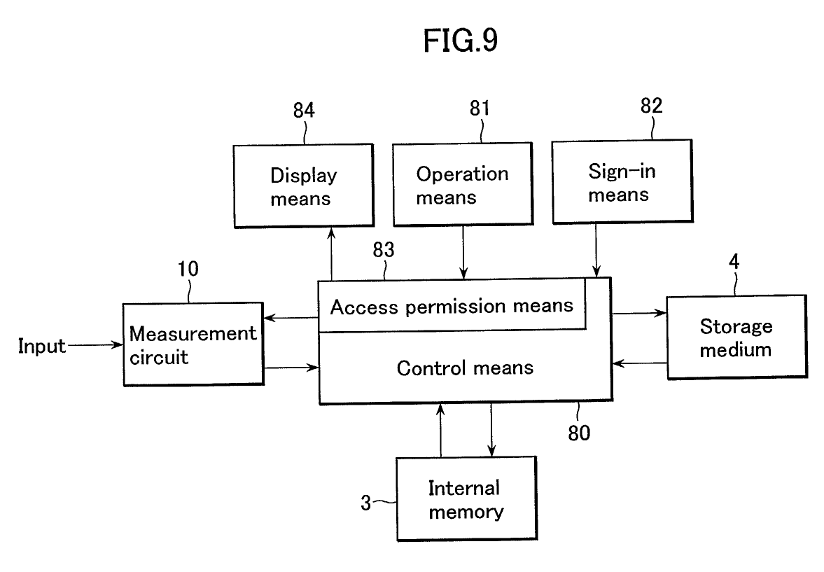

FIG. 9 is a drawing of a configuration showing embodiment 2 of the present invention. In FIG. 9, the same sections as those in the former drawings have the same signs.

The input is converted to electronic data in measurement circuit 10. Using the operations of memory start and memory stop, the digitized measurement data during the interval from memory start to memory stop are stored in internal memory 3 via control means 80.

Operation means 81 consists of key input, communication input, remote input, etc. and according to these types of input control means 80 executes operation and, at the same time, stores the contents, time, and user name of the operation in internal memory 3.

On the premise of equipment operation, user registration is executed from operation means 81, and the authority of operation is given only to a registered user by access permission means 83 provided in control means 80. Detailed contents of user registration include user name, user ID, password, etc. and these become user information. For the user name stored in the above internal memory, the information registered here is used.

This makes it possible to restrict the users who can operate the equipment as well as to specify the operating user. This enables security for the equipment to be ensured.

When the memory stop operation is done, the setup data for the equipment at the time of measurement, alarm and message information generated in the range of measurement data, user information, etc. are stored on storage medium 4 in the form of files, together with measurement data, and operation logs such as operation contents, time, user name, etc. stored in the internal memory.

By adding the user information to measurement data, the right to access data is given to only the registered users through access permission means 83 provided in control means 80.

Further, evidence of what was done when and by whom at the time of measurement can be kept by storing the operation logs.

In addition, the contents of the above stored files may be either stored in one combined file or stored as individual files corresponding to measurement data files.

After the files are stored, the measurement data in the measurement data files are read out from storage medium 4 and referenced with display means 84. When sign-in is executed from sign-in means 82 for data attestation, the data obtained by adding the sign information to the file read out via control means 80 are stored on storage medium 4. Details of sign information include signed user name, time, judgment of whether the measurement data are acceptable or not, comments, etc.

Further, by using a plurality of users' sign-ins and by making their sign-ins contain priority restrictions, for example, the administrator can execute sign-in after workers have signed in and so careful data administration can be achieved.

It is thus possible to devise measuring equipment which enables to handle restricting access to, storing operation logs for, and writing a signature to digitized data, and records generated by such measuring equipment can be handled equivalent to measurement records recorded with conventional chart recorders.

In addition, measurement data can be read out and sign-in can be executed with other equipment such as a personal computer by providing the storage medium outside the equipment. In this case, it is also possible to permit only those users registered in the equipment to access measurement data by using the user information stored in the outside storage medium.

Further, easy data alteration is prevented by making the data binary, and data alteration is made detectable by storing the check information to detect data alteration and by using the same data alteration detection method both in the equipment and a personal computer.

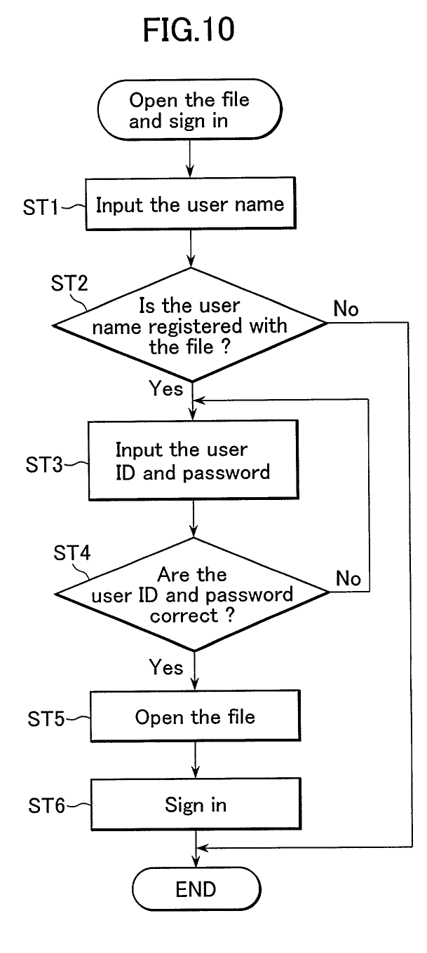

FIG. 10 shows a flowchart of an example procedure for sign-in by opening the file with a personal computer. Sign-in will be described according to the processing procedure shown in this flowchart.

(ST1) Enter the user name.

(ST2) Decide whether the user name is registered in the file.

(ST3) If the judgment in (ST2) is “yes,” enter the user ID and password. If the judgment in (ST2) is “no,” terminate the processing.

(ST4) Decide whether the user ID and password are correct.

(ST5) If the judgment in (ST4) is “yes,” open the file. If the judgment in (ST4) is “no,” again enter the user ID and password.

(ST6) Execute sign-in.

The present invention can provide excellent operability; for example, the measurement data can be made portable, and a digital signature can be affixed after checking the measurement data with other equipment in a remote place away from the measurement site, by providing a storage medium outside the equipment.

In addition, to the measuring equipment of the present invention, measurement data for handling official attestation in other industries may also be recorded, not limited to the pharmaceuticals industry.

As described above, the present invention can provide measuring equipment which can deal with restricting access to, storing operation logs for, and writing the signature to digitized data, and in which those data are handled as official data.

Thus, even digitized data can be handled equivalent to measurement records recorded with conventional chart recorders and so can also be used for audits by the U.S. Food and Drug Administration conducted, for example, in pharmaceuticals industry.

Furthermore, administration by a third party other than the worker is made possible by using two or more digital signatures and setting the order for entering each signature.

In addition, the present invention can provide excellent operability; for example, the digital signature can be signed checking the measurement data in a remote place away from the measurement site because the measurement data can be made portable by providing the storage medium outside the equipment, and measurement data can be read out and sign-in can be executed with other equipment such as a personal computer.

(Embodiment 3)

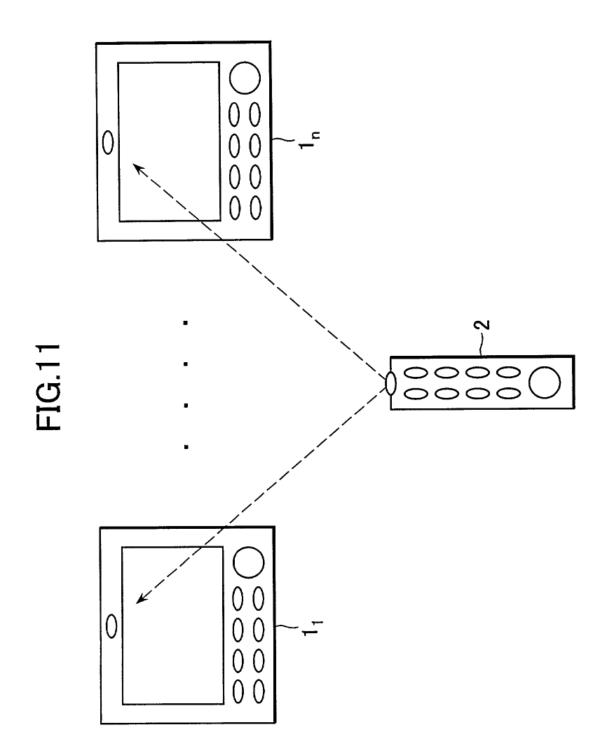

FIG. 11 is a conceptual configuration drawing showing embodiment 3 of the present invention. Measuring units 1₁ to 1ₙ are recorders of the same type and are configured so that the recorders within the angular field of view can be individually or collectively controlled using a spatial transmission signal such as infrared ray transmitted from remote control 2 if necessary.

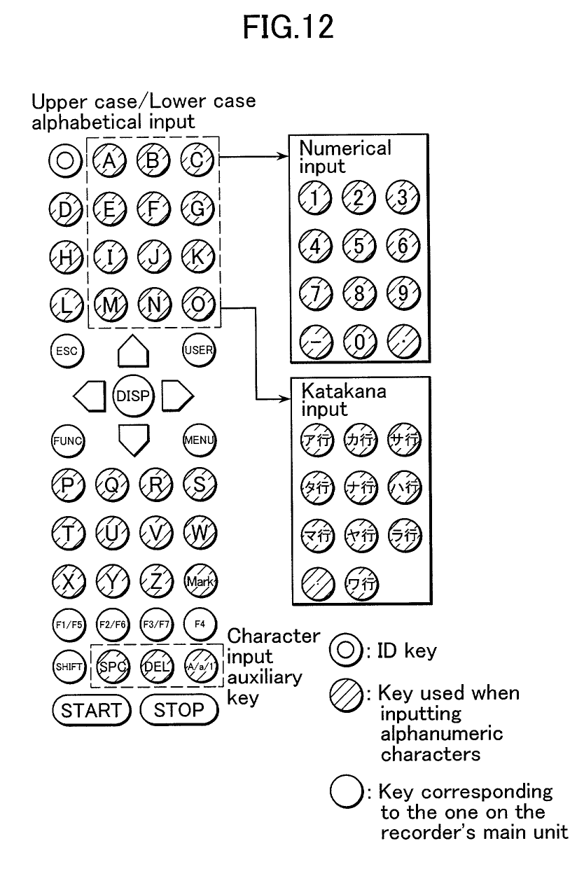

FIG. 12 shows a drawing showing an example of key arrangement for remote control 2. Keys are briefly divided into three categories: ID key designated with ⊚, keys used when inputting alphanumeric characters designated with oblique lines, and keys corresponding to those on the recorder's main unit having no mark. Operations equivalent to those using the keys provided in the recorder's main unit can be done using these keys. In this case, it is arranged such that operations with keys of the remote control and those from the keys in the recorder's main unit can be used jointly.

In FIG. 11, operations with remote control 2 become effective for recorder 1 in which a remote control ID coinciding with the ID code registered to remote control 2 is set. Accordingly, in order to use remote control 2, it is necessary to register the ID code to recorder 1 and to register the ID code to remote control 2.

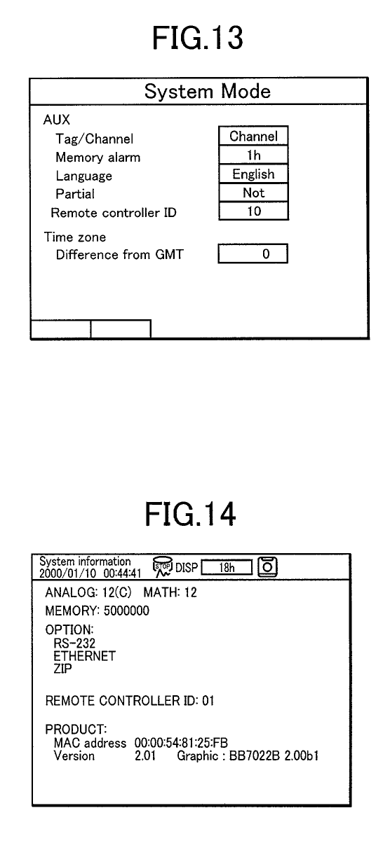

Registration of the ID code to recorder 1 is performed by changing over the display screen to the remote control ID setup screen as shown in FIG. 13 while setting, for example, recorder 1 to system mode and setting and entering any of OFF, or 0 to 31 using software keys. The setting status can be checked on the system information screen as shown in FIG. 14.

Registration of the ID code to remote control 2 is completed by pressing the “ID key,” then entering two-place numerals 0 to 31 starting at the higher place from numeral keys, and again pressing the “ID key.” In addition, it is arranged that, if a numeral key is not pressed, for example, for 8 seconds or more after pressing “ID key,” that ID code registration mode is ignored.

Further, in recorder 1 of the present invention, the information concerning the user having the operation authority must also be registered for the purpose of audit trails. Registration for these users can be carried out independently on the side of recorder 1 or on the side of remote control 2.

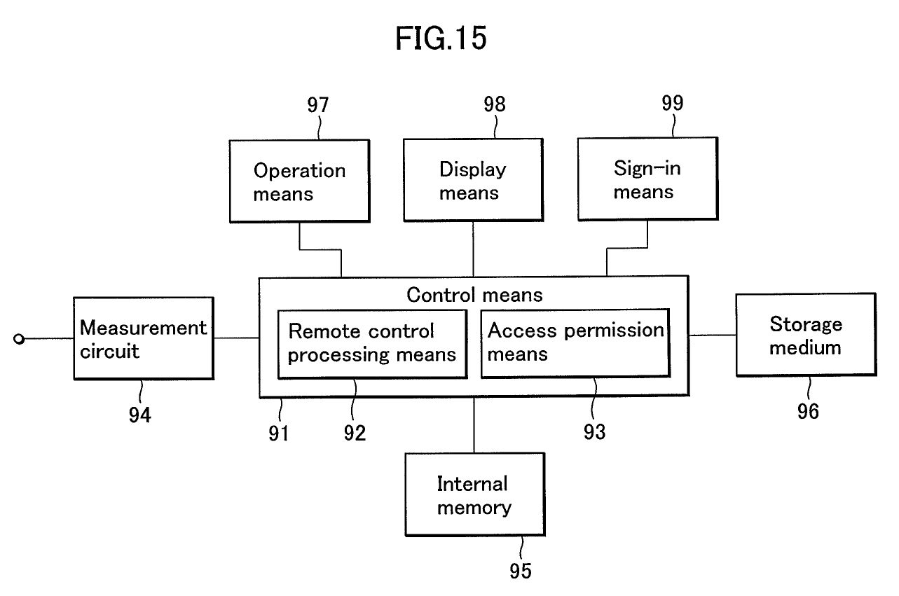

FIG. 15 is a block diagram showing a practical example of a recorder based on the present invention. First, remote control processing means 92 provided in control means 91 collates the registered remote control ID with that contained in the control signal transmitted from remote control 2 after receiving it and, if they coincide with each other, enables control of recorder 1 by remote control 2 by executing log-in operation based on the user's operation authority registered in access permission means 93 in advance. If necessary, processing before starting measurement such as a change in measurement conditions setup is carried out.

When measurement is started, input signals such as voltage are converted to digital data with measurement circuit 94, and these digital data are stored in internal memory 95 as measurement data from memory start to memory stop in a preset period via control means 91.

These measurement data stored in internal memory 95 are transferred to and stored on storage medium 96 in the form of files at memory stop. Further, on storage medium 96, information on displaying measurement data with waveforms, information on alarms and messages generated during measurement, and information on the user who executed memory start and memory stop, are also stored.

Operation means 97 consists of key input, communication input, remote input, etc. and control means 91 executes prescribed operations related to measurement as well as stores the contents, time, and user name of that operation in internal memory 95.

As the premise of operation of recorder 1, user registration must have been done from operation means 97 and for the authority to operate recorder 1, the right for the operation must be given only to the user registered by access permission means 93. Details of user registration include user name, user ID, password, etc. and these are the user information. For the user name to be stored in the above internal memory 95, the information registered here is used.

This makes it possible to restrict the users who can operate recorder 1 as well as to specify the operating user. Thus, security for recorder 1 can be ensured.

When the memory stop operation is done, setup data for recorder 1, information on alarms and messages generated in the range of measurement data, information on the user, etc. during the measurement are stored on storage medium 96 in the form of files, together with measurement data stored in internal memory 95 and operation logs such as the contents of operation, time, user name, etc.

As seen above, by adding user information to measurement data, the right to access the data is given to only the registered users through access permission means 93 provided in control means 91.

Further, evidence of what was done when and by whom at the time of measurement can be kept by storing operation logs.

In addition, the contents of the above stored files may be stored in a single file, or stored as individual files corresponding to measurement data files.

After the files are stored, measurement data files are read out from storage medium 96 and are referenced with display means 98. Then, sign-in is executed from sign-in means 99 for data attestation. When sign-in has been executed, sign information is added to files read out via control means 91 and those files are stored on storage medium 96. Details of sign information include the signed user name, time, judgment of whether the measurement data can be accepted or not, comments, etc.

Furthermore, by using a plurality of users' sign-ins and making their sign-ins contain priority restrictions, for example, the administrator can execute sign-in after workers have signed in and so careful data administration can be achieved.

It is thus possible to devise a recorder which deals with restricting access to, storing operation logs for, and writing a signature to digitized data, and recorders can be handled equivalently to measurement records recorded with conventional chart recorders.

In addition, measurement data can be read out and sign-in can be executed with other equipment such as a personal computer by providing the storage medium outside the equipment. In this case, it is also possible to permit only those users registered in the equipment to access measurement data by using the user information stored in the outside storage medium.

Further, easy data alteration is prevented by making the data binary, and data alteration is also made detectable by storing the check information to detect data alteration and by using the same data alteration detection method both in the recorder and a personal computer.

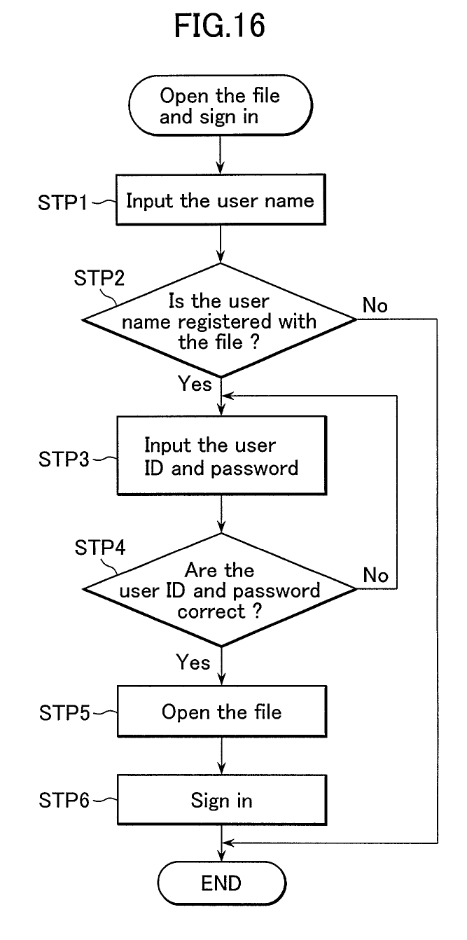

FIG. 16 shows a flowchart of example procedure for sign-in by opening the file with a personal computer. Sign-in will now be described according to the processing procedure shown in this flowchart.

(STP1) Enter the user name.

(STP2) Decide whether the user name is registered in the file.

(STP3) If the judgment in (STP2) is “yes,” enter the user ID and password. If the judgment in (STP2) is “no,” terminate the processing.

(STP4) Decide whether the user ID and password are correct.

(STP5) If the judgment in (STP4) is “yes,” open the file. If the judgment in (STP4) is “no,” again enter the correct user ID and password.

(STP6) Execute sign-in.

In the present invention, it is possible to make measurement data portable by providing storage medium outside the equipment.

This makes it possible to provide excellent operability; for example, a digital signature can be affixed after checking the measurement data with other equipment in a remote place away from the measurement site.

In addition, to the recorder of the present invention, measurement data for handling official attestations in other industries may also be recorded, not limited to the pharmaceuticals industry.

Although an example in which a recorder is the measuring equipment is described in the above embodiment, the present invention is not limited to a recorder but can be applied to whatever measurement result is recorded with electronic data such as, for example, a data logger.

Further, remote control is not limited to infrared ray but only needs wireless control, such as using electric waves or sound waves.

As stated above, the present invention can provide measuring equipment which can handle recorded results as official data suitable for audit trails and its operability is also improved. Thus, the equipment is sufficient for audits by the U.S. Food and Drug Administration conducted, for example, in the pharmaceuticals industry.

What is claimed is:

1. Measuring equipment which digitizes the prescribed input signals and records them as measurement data on a storage medium, provided with:
a measurement administration part in which administration data for equipment and measurement results are prepared prior to measurement,
a measurement files creating part in which measurement files composed of said measurement results are prepared and recorded on a storage medium during measurement, and
a sign-in part in which a digital signature is affixed to these measurement files after measurement.

2. Measuring equipment in accordance with claim 1, wherein said measurement administration part is provided with:
an administrator registration means which prepares the equipment administrator data,
an administrator attestation means which attests utilization of the equipment to said administrator,
an operating environment setting means in which said administrator prepares the data for equipment operating environment, and
a user registration means in which said administrator prepares the user list.

3. Measuring equipment in accordance with claim 1, wherein said measurement files creating part is provided with:
a user attestation means which attests utilization of the equipment to the user registered in said measurement administration part,
a measurement conditions setting means in which said user sets up measurement conditions for the equipment, and
a measurement execution means in which said user executes start and stop of measurement.

4. Measuring equipment in accordance with claim 1, wherein said sign-in part is provided with a signature attestation means which attests the digital signature of the user registered in said user list.

5. Measuring equipment in accordance with claim 1, wherein said measurement files creating part records at least one of the operation logs in the measurement conditions setting means, the data set up to the equipment at the time of measurement, and logs of changes to equipment settings, on a storage medium corresponding to the measurement data.

6. A method of creating measurement data, in which measurement data corresponding to the prescribed setup data are created by the following procedure:
(a) a process to prepare administration data for the equipment and measurement results prior to measurement,
(b) a process to create measurement files and records them on a storage medium during measurement, and
(c) a process to affix a digital signature to said measurement files from the equipment after measurement.

7. A method of creating measurement data in accordance with claim 6, wherein said process (a) includes at least one of the following processes:
a process for preparing administrator data for the equipment,
a process for attesting utilization of the equipment to said administrator,
a process in which said administrator prepares operating environment data for the equipment, and
a process in which said administrator prepares a user list.

8. A method of creating measurement data in accordance with claim 6, wherein said process (b) includes at least one of the following processes:
a process for attesting utilization of the equipment to the user registered in said measurement administration part,
a process in which said user sets up measurement conditions for the equipment,
a process in which said user executes start and stop of measurement, and
a process for recording measurement files prepared by making at least one of the operation logs, setup data in the equipment at the time of measurement, and logs of changes to equipment settings correspond to measurement data, on a storage medium.

9. A method of creating measurement data in accordance with claim 6, wherein said process (c) includes at least one of the following processes:
a process for attesting the digital signature of the user registered in said user list, and
a process for affixing a digital signature to said measurement files.

10. Measuring equipment recording digitized measurement data on a storage medium, in which user information including registration of the users who are given equipment operating authority and sign information on the user who has attested the equipment operating logs and measurement data, are made corresponding to said measurement data and recorded on said storage medium.

11. Measuring equipment in accordance with claim 10, wherein the following means are provided:
an operation means in which the equipment is operated,
a sign-in means in which a digital signature is affixed to measurement data, and
an access permission means in which access by the user registered in said user information is permitted and the functions of said operation means and said sign-in means are enabled for permitted access.

12. Measuring equipment in accordance with claim 11, wherein said user name permitted by said access permission means is recorded on said storage medium by making it correspond to measurement data.

13. Measuring equipment in accordance with claim 11, wherein said access permission means permits a plurality of sign-ins to be input in the setup sequence respectively.

14. Measuring equipment in accordance with any of claims 10 to 13 (both inclusive), wherein said storage medium is provided on each side or both sides of the inside and outside of the equipment.

15. Measuring equipment that is provided in number greater than one and configured to be individually or collectively controlled by spatially transmitting at least identification codes for collation and character symbol codes for setup input, from a remote control common to each measuring equipment, and control of the measuring equipment by said remote control being enabled by executing log-in operation based on the operation authority.

16. Measuring equipment in accordance with claim 15, wherein user information including registration of users having operation authority, operation logs for the equipment, and sign information on the user who attested measurement data, are recorded on a storage medium by being made to correspond to measurement data.

17. Measuring equipment in accordance with claim 15 or claim 16, having a sign-in means by which digital signatures are affixed to measurement data.

18. Measuring equipment in accordance with claim 17, wherein inputting is permitted to a plurality of sign-ins in the sequence set individually.

19. Measuring equipment in accordance with any of claims 15 to 18 (both inclusive), wherein said storage medium is provided at least on either the inside or outside of the equipment.
